(19) United States
(12) Patent Application Publication
(10) Pub. No.: US 2012/0305539 A1
(43) Pub. Date: Dec. 6, 2012

(54) HIGH-FREQUENCY HEATING DEVICE

(75) Inventors: Shinichi Sakai, Shiga (JP); Yuji Hayakawa, Shiga (JP); Masaharu Tsujimoto, Shiga (JP); Kuniaki Abe, Shiga (JP)

(73) Assignee: PANASONIC CORPORATION, Kadoma-shi, Osaka (JP)

(21) Appl. No.: 13/579,245

(22) PCT Filed: Feb. 16, 2011
(86) PCT No.: PCT/JP2011/000861

§ 371 Date: Aug. 15, 2012

(30) Foreign Application Priority Data
Feb. 16, 2010 (JP) 2010-030960

(51) Int. Cl. H05B 3/00

(52) U.S. Cl. 219/201

(57) ABSTRACT

A high-frequency heating device includes: a heating chamber configured to heat a food; a high-frequency generating unit configured to supply high frequency waves to the heating chamber; a driving power supply configured to drive the high-frequency generating unit; a cooling fan configured to cool the high-frequency generating unit and the driving power supply; an air guide serving as a blast guide of the cooling fan; and a noise filter configured to suppress a noise generated from the high-frequency generating unit and the driving power supply. The noise filter is attached on a cooling fan side of the air guide. A plurality of cooling holes are formed on a partition wall between a component mounting surface of a noise filter substrate and the air guide.

### TECHNICAL FIELD

The present invention relates to a cooling structure of a noise filter intended for suppressing an electromagnetic noise of a high-frequency heating device such as a microwave oven, and a structure of the noise filter incorporated into the high-frequency heating device.

### BACKGROUND ART

In related art, in a high-frequency heating device of this type, there is a noise filter attached to an air guide which also serves as a blast guide of a cooling fan (for example, see Patent Document 1).

Moreover, in another high-frequency heating device, there is a noise filter attached on an air flow path of cooling air in order to enhance an effect for cooling a passive element on the noise filter to improve a noise suppressing effect. The noise filter is attached to a wall surface on a cooling fan side of wall surfaces of an air guide serving as a blast guide for the cooling fan (for example, see Patent Document 2).

FIG. 4 shows the related-art high-frequency heating device described in the Patent Document 1.

As shown in FIG. 4, the high-frequency heating device includes a noise filter substrate 41, an air guide 42 serving as a blast guide, and a cooling fan 43.

Moreover, FIG. 5 shows the related-art high-frequency heating device described in the Patent Document 2.

As shown in FIG. 5, high-frequency heating device includes a noise filter substrate 51, a magnetron 52 serving as high-frequency oscillating means, a driving power supply 53 for driving the magnetron 52, and an air guide 54 serving as a blast guide for a cooling fan 55 and also serving to hold the driving power supply 53.

### RELATED ART DOCUMENTS

### Patent Documents

Patent Document 1: JP-A-11-159767

Patent Document 2: JP-A-07-106062

### SUMMARY OF THE INVENTION

### Problem to be Solved by the Invention

In the related-art structure described in the Patent Document 1, the noise filter substrate 41 is disposed outside a cooling path of the cooling fan 43 and is disposed in an upper part of a device chamber of the high-frequency heating device. For this reason, a wiring work for the noise filter substrate 41 can be simplified. However, a cooling performance of a heat generating component to be disposed on the noise filter substrate 41, such as a connecting portion of a fuse, a filter coil or a capacitor is deteriorated. As a result, the related-art structure has a problem of increasing a size of the filter coil in order to maintain a performance of the filter coil and the like.

In the related-art structure described in the Patent Document 2, the noise filter substrate 51 is disposed in the cooling path of the cooling fan 55. The structure is advantageous to the cooling performance of the connecting portion of the fuse to be the heat generating component, the filter coil or the capacitor. However, the device has a problem of complicate a wiring work for the noise filter substrate 51.

The invention has been made to solve the problems of the related art, and an object thereof is to provide a high-frequency heating device capable of simplifying a wiring work for a noise filter and reducing a size of a filter coil and the like while maintaining a cooling performance of the noise filter.

### Means for Solving the Problem

In order to solve the problems of the related art, there is provided a high-frequency heating device according to the invention including: a heating chamber configured to heat a food; high-frequency generating means for supplying high frequency waves to the heating chamber; a driving power supply configured to drive the high-frequency generating means; a cooling fan configured to cool the high-frequency generating means and the driving power supply; an air guide serving as a blast guide of the cooling fan; and a noise filter configured to suppress a noise generated from the high-frequency generating means and the driving power supply, wherein the noise filter is attached on a cooling fan side of the air guide, and wherein a plurality of cooling holes are formed on a partition wall between a component mounting surface of a noise filter substrate and the air guide.

With this configuration, a shortcut for cooling air can be produced by the holes provided on the air guide wall surface partitioned by the component mounting surface of the noise filter substrate and the air guide. Consequently, by disposing a heat generating component of the noise filter in the shortcut, it is possible to improve a cooling performance.

In the high-frequency heating device according to the invention, in addition to the above-described structure, a part of the holes formed on the wall surface is associated with a wiring portion of the noise filter.

With this configuration, a wiring work can be carried out by vertically inserting a wiring from the air guide surface. Consequently, it is possible to obtain a structure in which a wiring work in a process for assembling the high-frequency heating device can be compatible, and the cooling performance of the noise filter can be improved.

In the high-frequency heating device according to the invention, a part of the holes formed on the wall surface is associated with at least one of a capacitor and an inductor on the noise filter substrate.

With this configuration, even when the size of the capacitor component and/or the inductor component is increased to obtain a noise suppressing effect, an input/output terminal of the noise filter substrate can easily be inserted and pulled out. Further, since the large-sized component is often a heat generating component, the hole itself serves as a shortcut for a cooling path. Consequently, it is possible to provide an advantage for enhancing the cooling performance of the component.

### Advantages of the Invention

The present invention can provide a high-frequency heating device which can simplify a wiring work, which can maintain a cooling performance of a noise filter, and which can reduce a size of a filter coil and the like.

### BRIEF DESCRIPTION OF THE DRAWINGS

FIG. 1 is a perspective view showing a high-frequency heating device according to a first embodiment of the present invention.

FIG. 2 is a perspective view showing a main portion of a high-frequency heating device according to a second embodiment of the present invention.

FIG. 3 is a perspective view showing a main portion of a high-frequency heating device according to a third embodiment of the present invention.

FIG. 4 is a perspective view showing a main part of a first example of a related-art high-frequency heating device.

FIG. 5 is a side view of a second example of a related-art high-frequency heating device.

### MODE FOR CARRYING OUT THE INVENTION

A first aspect of the invention provides a high-frequency heating device according to the invention including: a heating chamber configured to heat a food; high-frequency generating means for supplying high frequency waves to the heating chamber; a driving power supply configured to drive the high-frequency generating means; a cooling fan configured to cool the high-frequency generating means and the driving power supply; an air guide serving as a blast guide of the cooling fan; and a noise filter configured to suppress a noise generated from the high-frequency generating means and the driving power supply, wherein the noise filter is attached on a cooling fan side of the air guide (a suction side of blast), and wherein a plurality of cooling holes are formed on a wall surface partitioned by between a component mounting surface of a noise filter substrate and the air guide. With this configuration, a shortcut for cooling air can be produced by the holes provided on the air guide wall surface partitioned by the component mounting surface of the noise filter substrate and the air guide. Consequently, by disposing a heat generating component of the noise filter in the shortcut, it is possible to improve a cooling performance.

A second aspect of the invention provides the high-frequency heating device according to the first aspect, wherein a part of the holes formed on the partition wall is associated with a wiring portion of the noise filter. With this configuration, a wiring work can be carried out from an upper portion of the air guide. Consequently, it is possible to obtain a structure in which a wiring work in a process for assembling the high-frequency heating device can be compatible, and the cooling performance of the noise filter can be improved.

A third aspect of the invention provides the high-frequency heating device according to the first or second aspect, wherein a part of the holes formed on the partition wall is associated with at least one of a capacitor and an inductor on the noise filter substrate. With this configuration, even when the size of the capacitor component and/or the inductor component is increased to obtain a noise suppressing effect, an input/output terminal of the noise filter substrate can easily be inserted and pulled out. Further, since the large-sized component is often a heat generating component, the hole itself serves as a shortcut for a cooling path. Consequently, it is possible to provide an advantage for enhancing the cooling performance of the component.

An embodiment according to the invention will be described below with reference to the drawings. The invention is not restricted to the embodiment.

### First Embodiment

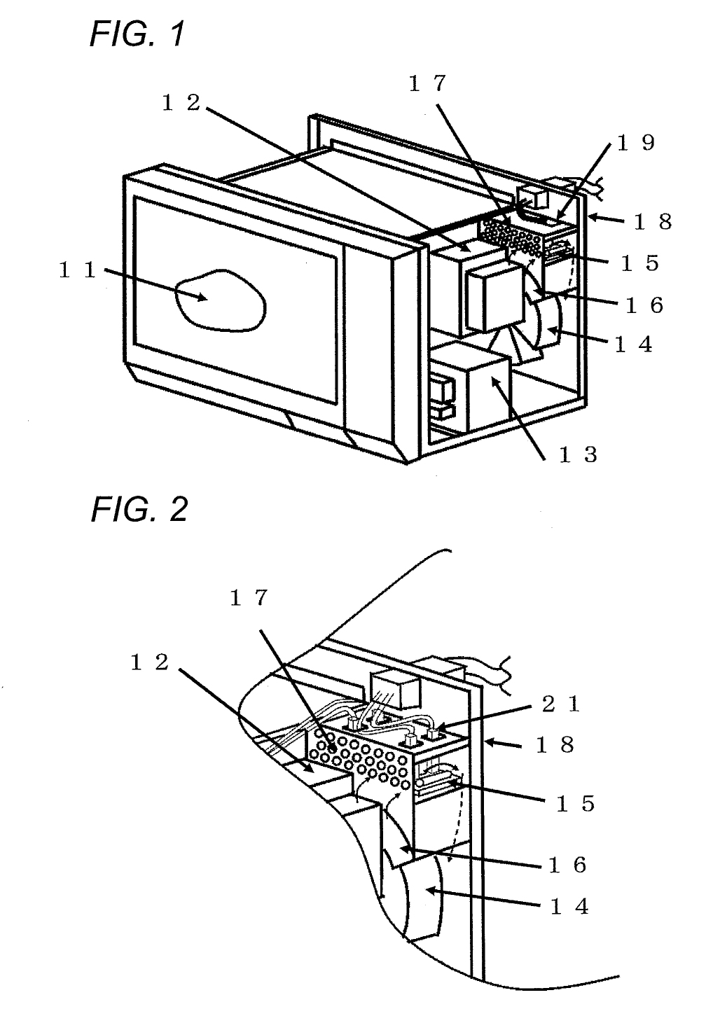

FIG. 1 is a perspective view showing a high-frequency heating device according to a first embodiment of the invention.

In FIG. 1, the high-frequency heating device includes: a heating chamber 1 configured to heat a food (not shown); high-frequency generating means 12 (a magnetron in the embodiment) for supplying a high-frequency power to the heating chamber; a driving power supply 13 configured to drive the high-frequency generating means; a cooling fan 14 configured to cool the high-frequency generating means 12 and the driving power supply 13; a noise filter 15 configured to suppress an electromagnetic noise generated from the high-frequency generating means 12 and the driving power supply 13; an air guide 16 configured to hold the cooling fan 14 and the noise filter 15; and a plurality holes 17 disposed on a partition wall surface of the air guide 16.

The operation and function of the high-frequency heating device having the structure described above will be explained below.

The holes 17 formed on the partition wall surface of the air guide 16 are provided on a surface on a high-frequency generating means 12 side of a space defined by a component surface of the noise filter 15 (which corresponds to an upper surface in FIG. 1) and the air guide 16. Consequently, as shown in the drawing, a part of cooling air supplied from the cooling fan 14 passes through the holes 17, cools a component of the noise filter 15, and returns to the cooling fan 14 via a space defined by a back plate 18 of the heating chamber and the noise filter 15. By intentionally providing the shortcut, the high-frequency heating device can enhance the cooling performance of the noise filter 15, and the noise filter 15 can easily be installed.

As described above, in the embodiment, the holes 17 provided on the air guide 16 are provided on a surface of a space defined by the component surface of the noise filter 15 and the air guide 16. Consequently, it is possible to produce a shortcut flowing over the component surface of the noise filter 15, to enhance the cooling performance of the noise filter 15, and to easily install the noise filter 15.

### Second Embodiment

FIG. 2 is a perspective view showing a main portion of a high-frequency heating device according to a second embodiment of the present invention. The reference numeral 21 denotes a housing for a receptacle which is provided on an input/output wiring for a noise filter 15. Other elements are assigned to the same reference numerals as those described in the first embodiment.

The operation and function of the high-frequency heating device having the structure described above will be explained below.

In the first embodiment, the wiring for the noise filter 15 is provided through a hole 19 in FIG. 1 (which is formed on an upper surface of the air guide 16). However, in a case where the air guide portion is one fixed, the wiring work requires disassembling of the air guide portion again, which is supposed to be a burden in a service. In FIG. 2, a hole is formed on the upper surface of the air guide 16 in association with an input/output terminal portion of the noise filter 15, and the wiring for the noise filter 15 is carried out through the hole.

Moreover, the wiring can also be carried out through a housing 21 for the receptacle as shown in the drawing.

As described above, in the embodiment, the hole is formed on a portion of the air guide 16 corresponding to the input/output terminal of the noise filter 15 such that the wiring work can be carried out after the air guide 16 incorporating the noise filter 15 previously is attached to a back plate 18 of a heating chamber 1. Thus, it is possible to maintain a cooling performance, and to implement an enhancement in workability for an assembly.

### Third Embodiment

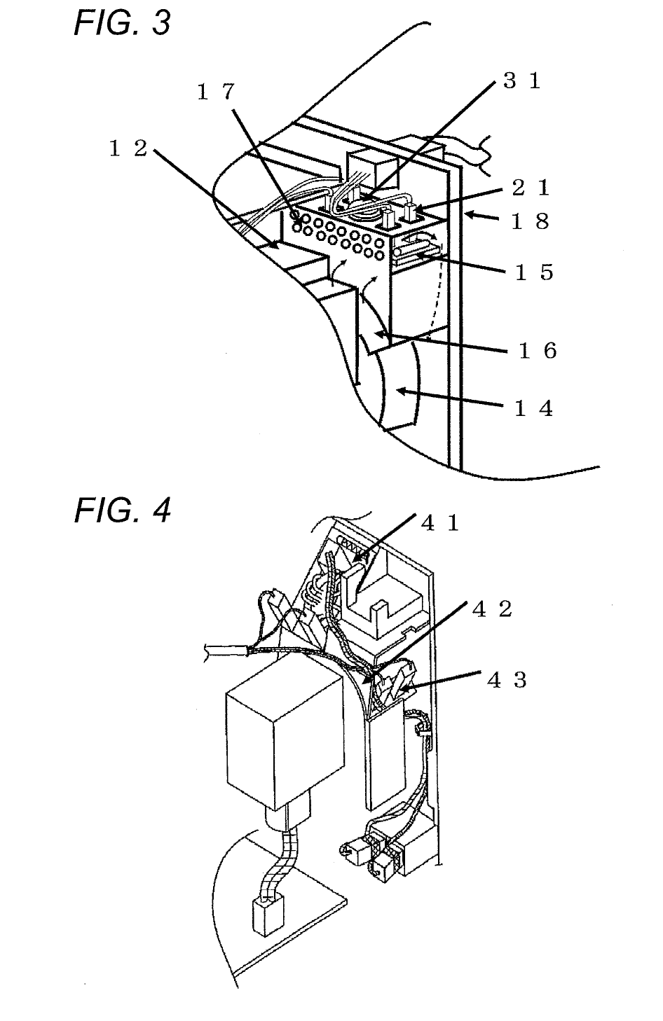

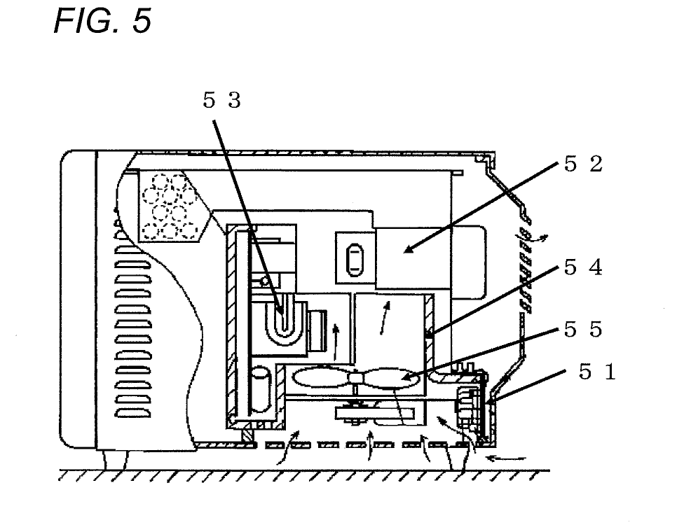

FIG. 3 is a perspective view showing a main portion of a high-frequency heating device according to a third embodiment of the present invention. The reference numeral 31 denotes a noise suppressing inductor (a common mode coil, in the embodiment). Other elements are assigned to the same reference numerals described in the first and second embodiments.

The operation and function of the high-frequency heating device having the structure described above will be explained below.

The noise filter 15 for the high-frequency heating device is usually includes the inductor 31 (the common mode coil), a capacitor (an X capacitor) provided between power lines at an input side/output sides of the noise filter 15, and two capacitors (Y capacitors) provided between the line at the output side and a ground.

The largest self-heating component with the operation is the inductor 31 (the common mode coil) and the second largest self-heating component is the capacitor (X capacitor).

A shortcut for cooling air is used for cooling the noise filter 15 according to the invention. Therefore, a shortage of cooling may be caused by a place of destination of the high-frequency heating device or a nominal output magnitude (a rated voltage, a rated current or a rated output in a region in which the high-frequency heating device is used).

For this reason, a hole is formed on an air guide 16 corresponding to the inductor component 31 (the common mode coil) of the noise filter 15 to protrude a part of the inductor component 31 from the air guide 16. As a result, the shortcut for the cooling air is provided at the portion, which can further enhance the cooling performance.

As described above, in the embodiment, it is possible to enhance the cooling performance for a component having large self-heating by forming a hole on a corresponding portion to the inductor component 31 of the noise filter 15 provided on the air guide 16.

Moreover, it is obvious that a similar structure can also be employed for a capacitor component (the X capacitor) serving as another heat generating component, in addition to the inductor component 31.

By changing a position of the noise filter according to the embodiment, it is particularly possible to enhance the cooling performance of the inductor component 31. Further, it is possible to provide an advantage that a wiring receptacle housing 21 for the noise filter 15 can easily be inserted and pulled out.

In some cases, it is possible to reduce a size of the inductor component by improving the cooling performance of the inductor component 31.

Although it is assumed that the air guide is formed by a resin in the embodiments, it is also possible to use an air guide formed of metal by ensuring a specific insulation distance.

The application is based on Japanese Patent Application No. 2010-030960) filed on Feb. 16, 2010, an entire content of which is incorporated herein by reference.

### Industrial Applicability

As described above, the invention can provide a high-frequency heating device in which a cooling performance of a noise filter is maintained, a wiring work can be simplified, and a size of a filter coil and the like can be reduced.

### Description of Reference Signs

14 Cooling Fan

15 Noise Filter

16 Air Guide

31 Inductor Component

1. A high-frequency heating device comprising:
a heating chamber configured to heat a food;
a high-frequency generating unit configured to supply high frequency waves to the heating chamber;
a driving power supply configured to drive the high-frequency generating unit;
a cooling fan configured to cool the high-frequency generating unit and the driving power supply;
an air guide serving as a blast guide of the cooling fan; and
a noise filter configured to suppress a noise generated from the high-frequency generating unit and the driving power supply,
wherein the noise filter is attached on a cooling fan side of the air guide, and
wherein a plurality of cooling holes are formed on a partition wall between a component mounting surface of a noise filter substrate and the air guide.

2. The high-frequency heating device according to claim 1, wherein a part of the holes formed on the partition wall is associated with a wiring portion of the noise filter.

3. The high-frequency heating device according to claim 1, wherein a part of the holes formed on the partition wall is associated with at least one of a capacitor and an inductor of the noise filter.

4. The high-frequency heating device according to claim 2, wherein a part of the holes formed on the partition wall is associated with at least one of a capacitor and an inductor of the noise filter.
